(19) United States
(12) Patent Application Publication
(10) Pub. No.: US 2026/0179231 A1
(43) Pub. Date: Jun. 25, 2026

(54) VIDEO DATA REDUCTION AND ANALYSIS USING OBJECT-BASED ADAPTIVE COMPRESSION AND PREDICTIVE MODELING

(71) Applicant: SK Hynix NAND Product Solutions Corp. (dba Solidigm), Rancho Cordova, CA (US)

(72) Inventors: Priyanka MUDGAL, Portland, OR (US); Rita H. WOUHAYBI, Portland, OR (US); Caleb MCMILLAN, Forest Grove, OR (US)

(21) Appl. No.: 19/000,383

(22) Filed: Dec. 23, 2024

(51) Int. Cl. G06T 7/20; G06T 7/12; G06T 7/70; G06V 10/25; G06V 10/60

(52) U.S. Cl. CPC G06T 7/20; G06T 7/12; G06T 7/70; G06V 10/25; G06V 10/60; G06T 2207/20084; G06V 2201/07

(57) ABSTRACT

This application is directed to intelligent video data management and processing optimization. A method includes receiving video streams and analyzing individual frames to extract comprehensive object metadata including physical characteristics, contextual information, and spatial relationships. The method also includes calculating movement scores for detected objects based on frame-to-frame variations and classifying objects into active or passive categories using these scores. The system dynamically predicts object movement probabilities by analyzing historical patterns, object characteristics, and inter-object relationships. The system selectively processes video content based on object importance and predicted behaviors, implementing adaptive storage mechanisms where active objects receive higher processing priority. The method manages video data through intelligent compression and selective processing, improving storage efficiency while maintaining critical information quality. The system addresses challenges of large-scale video management by implementing predictive mechanisms that anticipate and adapt to object behavior patterns.

### BACKGROUND

Video data generation has increased exponentially with the widespread deployment of cameras across various settings including healthcare facilities, manufacturing plants, and residential environments. This proliferation of video surveillance systems creates significant challenges in data storage and processing efficiency. For example, a typical home security camera generates continuous footage that frequently contains minimal frame-to-frame changes, resulting in substantial data redundancy and inefficient storage utilization. While existing video compression techniques attempt to address storage efficiency by maintaining frame deltas rather than complete frames, they often fail to discriminate between significant and insignificant changes. This leads to the storage of deltas that provide little value while consuming valuable storage resources. For instance, in a static scene captured by a home security camera, even minor changes in lighting or shadows may be recorded and stored, despite their lack of relevance to security monitoring purposes.

Moreover, conventional image analysis systems typically process entire frames to detect specific events, regardless of the distribution of relevant information within the frame. For example, in a manufacturing setting where the system needs to detect damaged boxes, each complete frame must undergo algorithmic analysis, consuming substantial computational resources and processing time. This approach proves inefficient, particularly when the events of interest affect only a small portion of the frame or occur infrequently. These challenges highlight the need for more intelligent video processing systems that can selectively capture and analyze relevant changes while minimizing computational overhead and storage requirements.

### SUMMARY

Accordingly, there is a need for systems and methods that address at least some of the problems described above. Embodiments of the present disclosure provide systems and methods for intelligent video data management through dynamic object analysis, predictive behavior modeling, and adaptive compression. The system described herein addresses technical challenges in managing large-scale video data by performing comprehensive object characterization including location, physical characteristics, semantics, and contextual relationships, adaptive compression based on object dynamics and importance, and/or predictive modeling of object behaviors and synthetic scene generation.

The disclosed technology provides concrete technical improvements over conventional video processing systems by significantly reducing storage requirements and computational overhead through intelligent scene understanding and predictive analysis. Unlike traditional approaches that process entire frames or store uniform-quality video data, the present system employs sophisticated machine learning techniques to segment scenes into regions of interest and adaptively compress content based on object importance. This intelligent approach, combined with dynamic movement scoring that considers factors, such as object interactions, spatial relationships, and behavioral patterns, represents a technical solution that cannot be practically performed by the human mind due to the complexity of real-time video analysis and the scale of object tracking required.

The technology described herein addresses particular technical problems in video data management through specific technical solutions. For example, according to some embodiments, the system tackles the challenge of inefficient video storage and processing by implementing deep learning-based networks, such as transformer-based networks or convolutional neural networks, for object segmentation, coupled with a multi-tiered compression system that optimizes storage based on predicted object behaviors. Some embodiments further incorporate synthetic scene generation capabilities to enhance AI model training without requiring extensive real-world data collection. These technical features, combined with the implementation of sliding window predictions for continuous optimization and the use of memory-based AI algorithms for future state prediction, constitute significantly more than conventional approaches and demonstrate a clear practical application in improving video surveillance and analysis system performance.

In one aspect, a method is implemented by a computing system to reduce video data storage and improve processing efficiency. The method includes receiving a video stream comprising a plurality of frames, analyzing the video stream to identify one or more objects, and extracting object metadata associated with the one or more objects from the video stream. The object metadata including at least location information of the one or more objects. The method further includes determining movement characteristics of the one or more objects based on the object metadata and selecting at least a subset of the plurality of frames in the video stream based on the object metadata and the movement characteristics of the one or more objects for further processing, wherein the subset of the plurality of frames includes less than all of the plurality of frames.

In one aspect, a method is provided for reducing video data storage and improving processing efficiency in a computing system. The method includes receiving a video stream comprising multiple frames. The method also includes analyzing each frame to identify and segment objects. For each object, metadata is extracted comprising object class, physical semantics, contextual characteristics, and location information. The method also includes assigning movement scores to objects based on detected movements across consecutive frames. The method also includes categorizing objects as active or passive based on their movement scores. The method also includes predicting movement probabilities for objects based on their characteristics, context, and relationships with other objects. The method also includes utilizing the analyzed object information, including object metadata, movement scores, categorizations, and predicted probabilities, to selectively process video content based on object importance and predicted behaviors, thereby reducing video data storage requirements and improving processing efficiency through smart data management.

In some embodiments, the segmentation of objects uses image segmentation methods based on transformers or convolutional neural networks.

In some embodiments, assigning movement scores comprises using pixel-level difference calculation or flow-based techniques to detect object movements between consecutive frames.

In some embodiments, predicting movement probabilities utilizes machine learning or statistical learning algorithms including Bayesian methods, Gaussian mixture models, and transformer-based models.

In some embodiments, the contextual characteristics include spatial relationships, functional roles within the scene, and potential interactions with other objects.

In some embodiments, the method includes capturing metadata of light sources in the frame, including location and intensity, to account for their impact on visual perception.

In some embodiments, the method includes storing, in a database, object details comprising frame ID, absolute location, relative location to other objects, movement score, metadata, movement probability, and contextual relationships with other objects.

In some embodiments, predicting movement probabilities includes considering the object's current position relative to other objects in the scene and updating probabilities based on changes in spatial and/or contextual relationships.

In some embodiments, the method includes adaptively compressing frame data based on object categorization and movement metrics. This includes storing high-resolution images of active objects and low-resolution images of passive objects, and applying weighted encoding bitrates that use higher bitrates for interesting regions.

In some embodiments, adaptively compressing frame data includes storing high-resolution images of active objects and low-resolution images of passive objects, and applying weighted encoding bitrates that use higher bitrates for interesting regions and lower bitrates for uninteresting regions.

In some embodiments, determining interesting regions within objects uses an attention mechanism from transformer architecture in deep learning.

In some embodiments, the method includes adjusting the frequency of storing high-resolution images for passive objects based on their predicted likelihood of becoming active.

In some embodiments, the method includes retrieving object details from a database for a specific frame and recreating a scene based on the object details, using absolute and relative object locations, and adjusting object resolutions based on their stored compression information.

In some embodiments, utilizing the analyzed object information includes predicting future object locations, contexts, and metadata for subsequent frames, and detecting unexpected behaviors by comparing predicted and actual object states, wherein predicting future object states and detecting unexpected behaviors improves processing efficiency by enabling targeted analysis of relevant frame regions and early detection of anomalies.

In some embodiments, predicting future object states uses memory-based AI algorithms, including Long Short-Term Memory (LSTM), Convolutional LSTM networks, and transformer-based models.

In some embodiments, detecting unexpected behaviors includes comparing predicted and actual object states using image processing techniques and/or statistical or machine learning-based similarity measures.

In some embodiments, predicting future object states includes predicting direction, speed of movement, and potential interactions for active objects.

In some embodiments, the method includes dynamically adjusting the time interval for prediction based on the rate of change in the scene.

In some embodiments, the method includes triggering alerts or actions when detected unexpected behaviors exceed a predefined threshold of deviation from predictions.

In some embodiments, the method includes dynamically adjusting the threshold based on feedback from subject matter experts or automated learning processes.

In some embodiments, predicting future object locations, contexts, and metadata includes utilizing a sliding window approach where data from past n frames is used to predict details for the next m frames, enabling continuous updating of predictions based on the most recent data.

In some embodiments, utilizing the analyzed object information includes generating synthetic scenes representing rare events based on aggregated data from multiple environments, wherein generating synthetic scenes reduces video data storage requirements by eliminating the need to store large volumes of real video data.

In some embodiments, generating synthetic scenes includes aggregating data across multiple environments using clustering, principal component analysis, or deep learning techniques, extracting high-level features of backgrounds and objects, generating diverse backgrounds, and positioning synthetic objects using large language or vision models.

In some embodiments, the method includes validating synthetic scenes using statistical comparison with real data, quality metrics, semantic consistency checks, or human-in-the-loop verification.

In some embodiments, generating synthetic scenes includes maintaining environment-specific fidelity based on an intended use case of the synthetic data.

In some embodiments, generating synthetic scenes includes creating anomalous situations to improve the robustness of AI model training for rare event detection.

In some embodiments, generating synthetic scenes includes extracting objects and features from different environments, combining objects to create novel scenarios, and maintaining environment-specific fidelity while introducing unexpected elements.

In some embodiments, generating synthetic scenes includes generating consecutive frames with motion details, storing the frames, and combining them to produce synthetic videos for AI model training without requiring additional real-world video storage.

In some embodiments, the method includes categorizing objects as either active or passive further based on their movement scores and predicted movement probabilities.

In another aspect, a computing system includes one or more processors, memory, and one or more programs stored in the memory. The programs are configured for execution by the one or more processors. The programs include instructions for performing any of the methods described herein.

In another aspect, a non-transitory computer readable storage medium stores one or more programs configured for execution by one or more processors of a computing system. The programs include instructions for performing any of the methods described herein.

These illustrative embodiments and implementations are mentioned not to limit or define the disclosure, but to provide examples to aid understanding thereof. Additional embodiments are discussed in the Detailed Description, and further description is provided there.

### BRIEF DESCRIPTION OF THE DRAWINGS

FIG. 1 is a block diagram of an example system for intelligent video data management, according to some embodiments.

FIG. 2A is a schematic diagram of an example object analysis pipeline, according to some embodiments.

FIG. 2B illustrates an example adaptive compression framework, according to some embodiments.

FIG. 2C shows an example prediction system, according to some embodiments.

FIG. 2D shows an example synthetic scene generation pipeline, according to some embodiments.

FIG. 2E shows an example database schema for scene recreation, according to some embodiments.

FIG. 2F shows a schematic diagram of an example tuning of time interval for prediction, according to some embodiments.

FIG. 3 shows a block diagram of an example computing device for video data management and processing, according to some embodiments.

FIG. 4 is a flowchart of an example method for video data management, according to some embodiments.

FIG. 5 is a flowchart of another example method for video data management, according to some embodiments.

Like reference numerals refer to corresponding parts throughout the drawings.

### DESCRIPTION OF IMPLEMENTATIONS

Reference will now be made to various implementations, examples of which are illustrated in the accompanying drawings. In the following detailed description, numerous specific details are set forth in order to provide a thorough understanding of the invention and the described implementations. However, the invention may be practiced without these specific details. In other instances, well-known methods, procedures, components, and circuits have not been described in detail so as not to unnecessarily obscure aspects of the implementations.

This patent application includes examples with specific numerical values to illustrate certain embodiments of the invention. These values are provided solely for illustrative purposes and are neither exhaustive nor restrictive. Their purpose is to aid in understanding the invention and its potential applications. Accordingly, the scope of the invention is not confined to the disclosed numerical values but extends to variations, modifications, interpolations, derivations, and equivalents that would be reasonable to those skilled in the art.

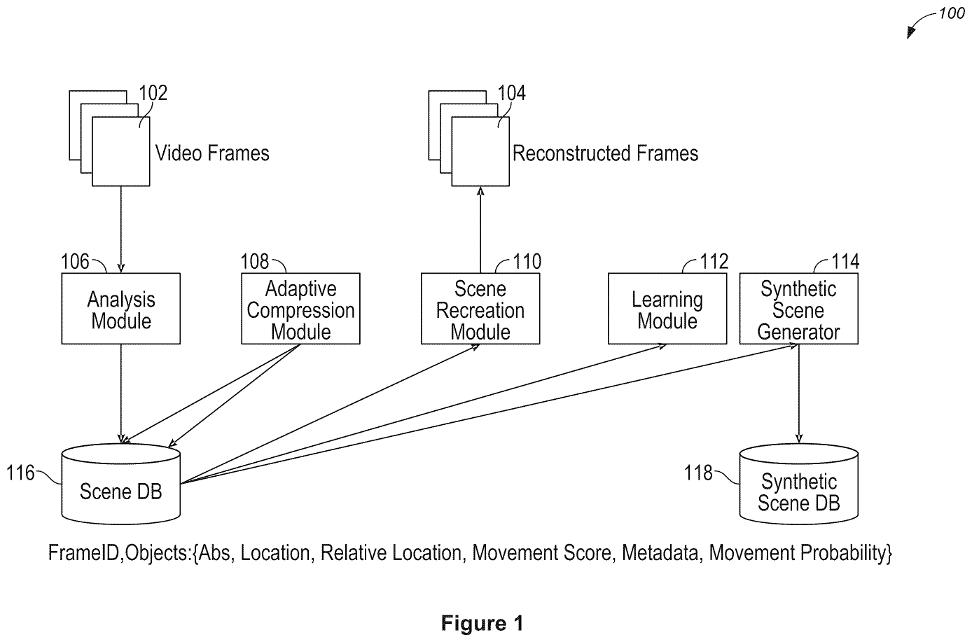

The exponential growth in video data generation across diverse domains, from healthcare monitoring to manufacturing quality control to consumer applications, presents significant challenges for storage and processing efficiency. While traditional video compression techniques help reduce storage needs, they often fail to distinguish between meaningful and insignificant changes in scene content. To address these limitations, the present disclosure introduces an intelligent video data management system that combines object based analysis, adaptive compression, and predictive modeling. The techniques described herein enable more efficient data storage and processing by understanding scene dynamics, selectively preserving high quality data for important objects and events, while intelligently compressing less critical content. The system's adaptability makes it suitable for any application where intelligent video processing and storage optimization are needed. Disclosed embodiments enable intelligent video data management. Systems, methods and devices implementing the techniques in accordance with some embodiments are described below in reference to FIGS. 1-4.

FIG. 1 is a block diagram of an example system 100 for intelligent video data management, according to some embodiments. The system 100 includes a video analysis module 106 (sometimes referred to as an analysis module) that performs object segmentation and/or characterization on video frames 102. The output of the analysis module 106 is input to an adaptive compression module 108, a scene recreation module 110, a learning module 112, and/or a synthetic scene generator 114. The adaptive compression module 108 manages storage optimization. The processed and compressed output includes optimized video data. The learning module 112 predicts object behaviors and detects anomalies. The synthetic scene generator 114 creates training data for rare events, which may be stored in a synthetic scene database 118. The scene recreation module 110 recreates or reconstructs scenes, which may be stored as reconstructed frames 104. In some embodiments, the modules interact via a scene database 116 that stores object metadata, movement scores, and/or scene information. The scene database 116 and/or the synthetic scene database 118 may be organized to store frame identifier (frame ID), object attributes, including, for example, absolute location, relative location, movement score, metadata, and/or movement probability.

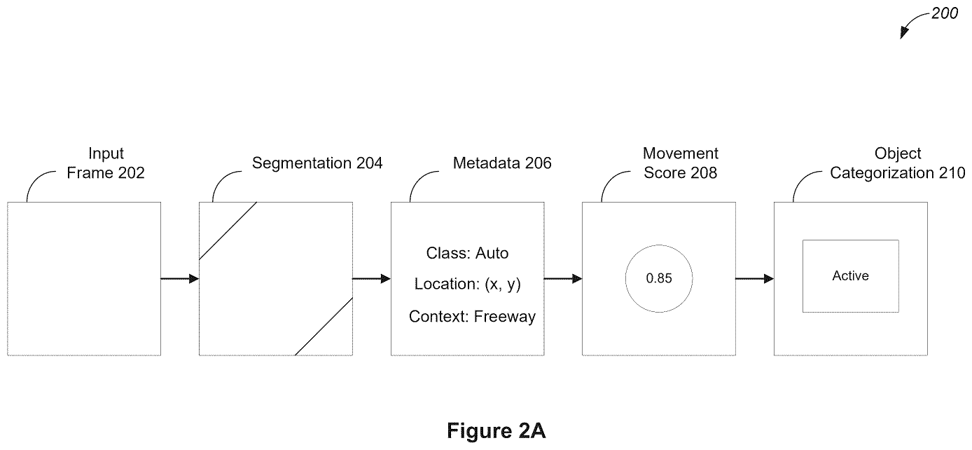

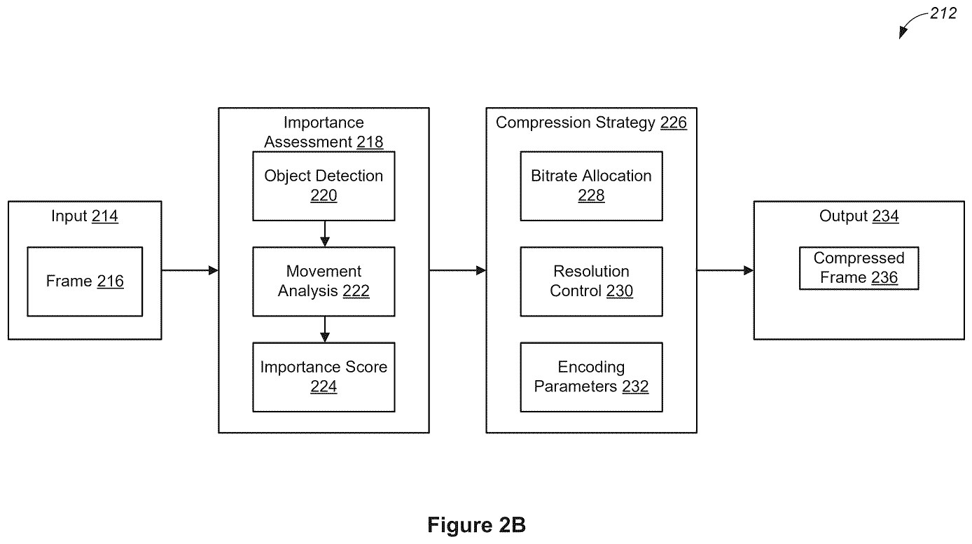

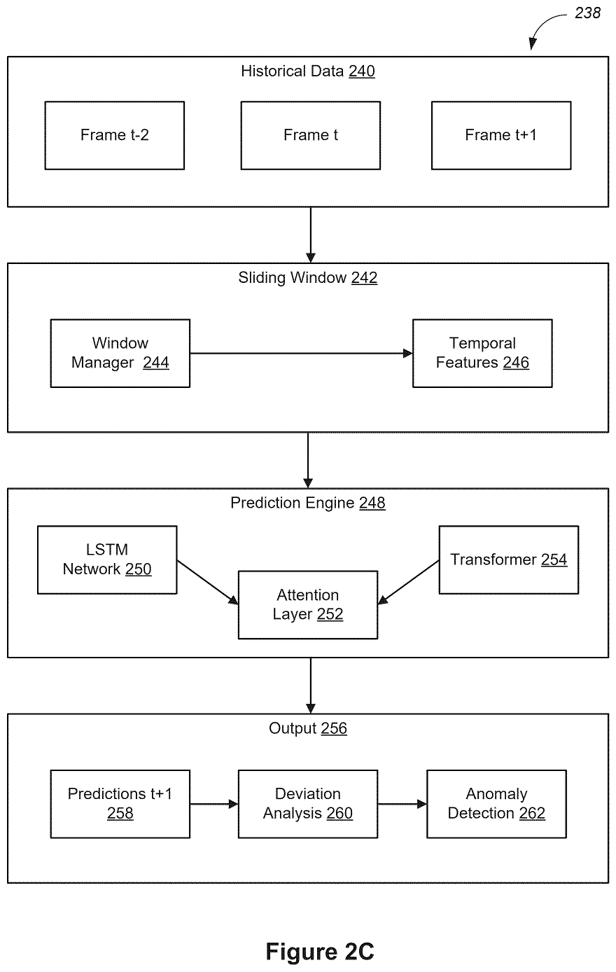

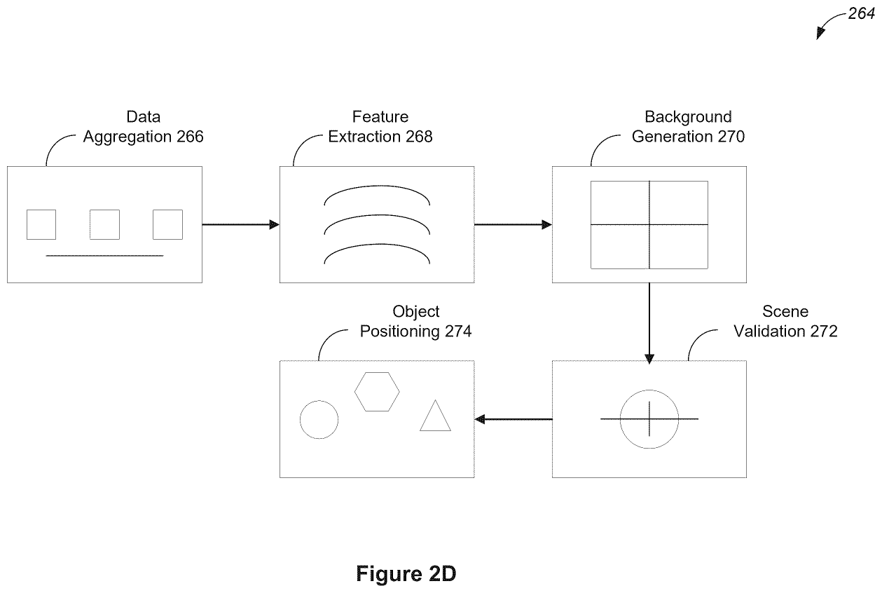

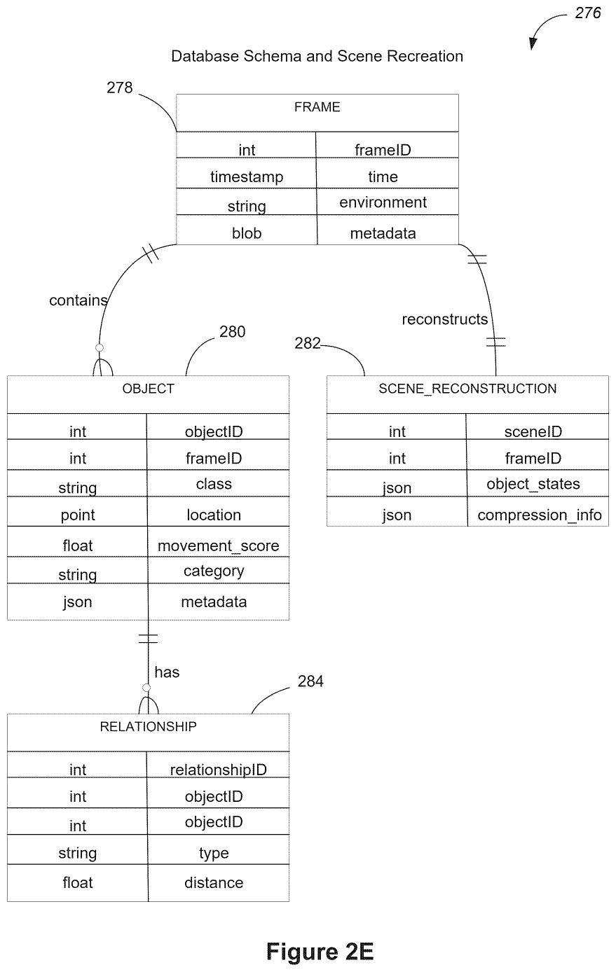

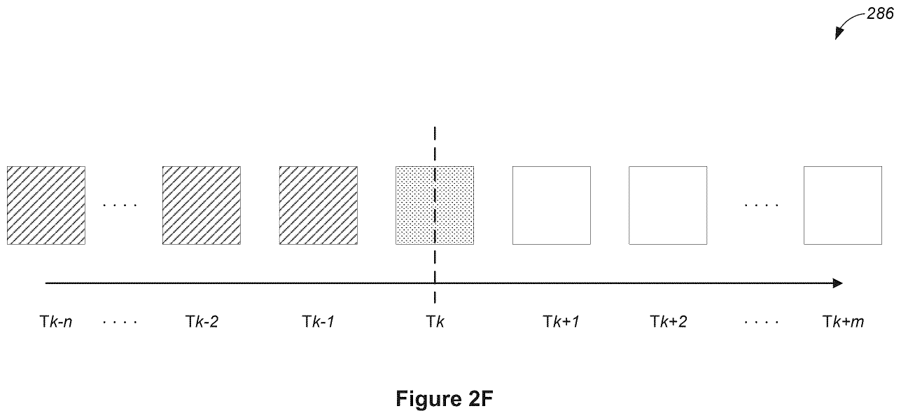

FIG. 2A is a schematic diagram of an example object analysis pipeline 200 (sometimes referred to as the analysis module), according to some embodiments. Input frames 202 are processed through segmentation 204, which may use transformer-based or CNN methods to identify objects. Metadata extraction 206 captures metadata for objects, which may include, for example, object class, location, context, and/or physical characteristics. Movement scoring 208 assigns activity scores or movement scores based on frame-to-frame changes (e.g., based on the metadata). Object categorization 210 categorizes objects (e.g., active or passive) based on the movement scores. In this way, the object analysis pipeline 200 perform several tasks.

To illustrate, suppose at time TO, the object analysis pipeline 200 receives a first video frame and subsequently receives consecutive frames at T1, T2, . . . Tm. The object analysis pipeline 200 segments various objects of interest from the first frame using image segmentation methods, such as Segment Anything Model (SAM), or other segmentation specific methods based on transformers or convolutional neural networks. Subsequently, the object analysis pipeline 200 extracts the metadata for those objects including, for example, the object class, physical semantics, contextual characteristics (e.g., object positions in the frame can give clues about their function or the spatial relationship between them), absolute location in the frame, and/or relative location. The object analysis pipeline 200 also captures the metadata (e.g., location, intensity) of light sources as such sources may not be visible in the image but may impact the visual perception of the frame. Consider an example of a camera facing a person sitting on a chair, with a painting on the wall, and a bookshelf in the background. Analyzing the image, the object analysis pipeline 200 identifies objects of interests, such as “a person, “a bookshelf, “a painting”, “books” with locations:
Absolute location—Person [50, 30, 150, 100], books [80, 60, 120, 90]
Relative distance—Person-books [30,−30, 30, 10].

Subsequently, the object analysis pipeline 200 detects the movements of the objects in consecutive frames, and/or assign movement scores to various objects. For detecting the movements, image processing methods, such as pixel level difference calculation or flow-based techniques, may be used. Based on an object's change of position in the frames, the object analysis pipeline 200 categorizes them as either an “active” or “passive” object of interest (or any similar categorization, such as fast moving, slow moving objects, and so on). Continuing the example, only the person is a potential candidate that can change location while the rest are static. Thus, the person may be assigned a high movement score, and static objects may be assigned a low score, in a range (e.g., 0 to 1). The numerical examples mentioned herein are not intended to be exhaustive or to limit the scope of the inventions to the precise examples disclosed, and many modifications and variations of the example models are possible in view of the above teachings.

Based on the relative locations, contextual characteristics, metadata, and movement scores, the object analysis pipeline 200 then predicts the movement probability for all the objects. For example, the probability of a person moving will be much higher than the bookshelf moving. However, the probability of a book moving with a person standing close to it is higher. Any probability estimation or likelihood prediction algorithms in machine learning, statistical learning techniques, such as Bayes, gaussian mixture, can be used for this purpose. The output details may be stored in a region database using a predetermined format (e.g., {frame ID, objects: {absolute location, relative location, movement score, metadata, movement probability}}. This example format is not intended to be exhaustive or to limit the scope of the inventions to the precise examples disclosed, and many modifications and variations of the example format are possible in view of the above teachings.

FIG. 2B illustrates an example adaptive compression framework 212, according to some embodiments. The framework processes input 214, which may include video frames 216, through importance assessment 218, which may include object detection 220, movement analysis 222, and/or importance scoring 224. Some embodiments include a compression strategy 226, which may include bitrate allocation 228 and/or resolution control 230. Encoding parameters 232 are applied to generate compressed output 234, which may include compressed frames 236. In this way, the adaptive compression framework 212 performs adaptive compression on objects of interest. In some embodiments, the adaptive compression framework 212 saves the high-resolution images of active objects and low-resolution images of passive ones. In some embodiments, the adaptive compression framework 212 stores high resolution of passive objects but may lower the frequency considerably (compared to active objects).

In some embodiments, the adaptive compression framework 212 stores only a small patch for uninteresting details within an object. The uninteresting details/regions could be determined by using attention mechanism from transformer architecture in deep learning. For example, a wall in a background may be uninteresting as the wall does not change at all. The attention mechanism, for example, determines interesting and uninteresting regions by computing attention scores for each spatial location within detected objects. The adaptive compression framework 212 can calculate these scores using a multi-head self-attention network that processes feature maps at multiple scales. Attention scores above a predetermined threshold (e.g., 0.6) indicate interesting regions, while scores below a predetermined threshold (e.g., 0.3) indicate uninteresting regions. The network computes attention weights by evaluating spatial and temporal relationships between features, considering factors, such as motion patterns, object interactions, and contextual relevance. Using the information of interesting versus uninteresting regions in a video frame, the adaptive compression framework 212 can also use a weighted encoding bitrate that would apply a much higher bitrate to the interesting regions, while using a minimal number of bits in the uninteresting regions. This would enable the entire frame to be stored while still adaptively compressing the uninteresting regions of data. In some embodiments, the adaptive compression framework 212 stores the details of applied compression and associated blobs of specific regions in a region database (e.g., the scene database 116).

FIG. 2C shows an example prediction system 238, according to some embodiments. The learning module 112 can be implemented as the prediction system 238. In some embodiments, the prediction system 238 includes temporal analysis to predict object behaviors and detect anomalies. The system 238 processes historical data 240 (e.g., frame t−2, frame t, frame t+1) through a sliding window mechanism 242, where a window manager 244 handles temporal features 246 extracted from sequential frames. The analysis can be configured to operate at various time intervals, such as every fifth frame, tenth frame, or alternate frames, providing flexibility in temporal granularity. The prediction system 238 includes a prediction engine 248, which can include advanced neural network architectures including, but not limited to, memory-based AI algorithms, such as long-short term memory (LSTM) networks 250 or ConvLSTM, attention layers 252, and/or transformers 254. These example models are not intended to be exhaustive or to limit the scope of the inventions to the precise examples disclosed, and many modifications and variations of the example models are possible in view of the above teachings.

In some embodiments, the prediction engine 248 analyzes past “n” frames to predict object characteristics in the subsequent “m” frames, including their locations, contextual relationships, and movement metadata, such as direction and speed. FIG. 2F shows a schematic diagram of an example tuning 286 of time interval for prediction, according to some embodiments. Every nth frame (e.g., frame at Tₖ, after frames at Tₖ₋ₙ, . . . , Tₖ₋₁) predicts the next m frames (e.g., frames at Tₖ₊₁, . . . , Tₖ₊ₘ). The system maintains continuous monitoring of these predictions against actual outcomes through deviation analysis 260 and anomaly detection 262. Various comparison techniques can be used, from pixel-to-pixel comparison to statistical similarity measures like cosine similarity, to identify when deviations exceed acceptable thresholds. The practical applications of the prediction system 238 are diverse. In a simple scenario, the prediction system 238 can monitor a person's eye or head movements, flagging unexpected stationary behavior. In industrial settings, such as manufacturing cells with multiple robotic arms, the prediction system 238 can detect deviations from expected movement patterns, triggering appropriate actions (e.g., alarms) when anomalous behavior is identified.

FIG. 2D shows an example synthetic scene generation pipeline 264, according to some embodiments. The pipeline includes data aggregation 266, feature extraction 268, background generation 270, scene validation 272, and/or object positioning 274. In some embodiments, to display a data again, the synthetic scene generation pipeline 264 fetches details from a region database (e.g., the scene database 116) for a specific frame and starts constructing the scene using the object's absolute location, relative location to other objects, compression, and/or metadata. In some embodiments, the synthetic scene generation pipeline 264 adjusts the resolution to retain close-to original resolution.

The synthetic scene generation pipeline 264 can be used to create comprehensive training data, with particular emphasis on rare events. In some embodiments, the process begins with data aggregation 266, employing various analytical techniques including clustering, principal component analysis, correlation analysis, and deep learning methods, such as CNNs and transformers, to consolidate information across multiple environments. Scene construction follows a methodical approach, beginning with feature extraction 268 of both backgrounds and objects. The pipeline then proceeds to background generation 270 using modeling software or procedural generation methods. In some embodiments, object positioning 274 uses large language models to place objects while maintaining appropriate spatial relationships and ensuring environment-specific fidelity. Each generated scene preserves motion details including speed and directional information, for example.

In some embodiments, the pipeline 264 maintains environment-specific fidelity through a multi-stage validation process. For example, for each environment type (e.g., indoor, outdoor, industrial), the pipeline 264 maintains statistical models of typical object distributions, lighting conditions, and/or spatial relationships. These models can include permitted object classes, typical object dimensions, valid spatial arrangements, and/or expected lighting ranges. Generated scenes must match these environmental constraints within specified tolerances. For example, object dimensions within ±10% of expected ranges, lighting intensity within ±15% of environment-specific baseline, spatial relationships conforming to environment-specific rules with 90% confidence, and so on. The numerical examples mentioned herein are not intended to be exhaustive or to limit the scope of the inventions to the precise examples disclosed, and many modifications and variations of the example models are possible in view of the above teachings.

Building upon the scene construction pipeline described above, in some embodiments, the pipeline 264 evaluates scenario plausibility using a multi-factor scoring system. For example, scenarios must satisfy the following criteria to be considered plausible: (1) physical feasibility, validated through the same analytical techniques used in data aggregation 266, including correlation analysis to verify that object interactions comply with basic physics constraints; (2) statistical likelihood, measured using the clustering and principal component analysis methods referenced above to ensure object configurations match historical patterns (e.g., within 2 standard deviations); and (3) semantic coherence, evaluated using the transformer-based deep learning methods to verify that object relationships align with predefined scene graphs (e.g., with at least 80% confidence). These plausibility metrics can be applied during both feature extraction 268 and object positioning 274 phases to maintain consistency with the environment-specific fidelity requirements of the synthetic scene generation process.

In some embodiments, the scene validation 272 includes a multi-faceted approach to ensure quality and realism. This can include, for example, statistical comparison with real data, quality metrics assessment, semantic consistency verification, and human-in-the-loop validation where necessary. Special attention is given to rare events, where outlier detection helps identify anomalous situations. For instance, the system might flag potentially dangerous scenarios, such as a toddler's proximity to heavy dumbbells in a gym setting. These edge cases provide particularly valuable training data for improving AI algorithm prediction accuracy.

FIG. 2E shows an example database schema 276 for scene recreation, according to some embodiments. The database schema 276 provides a structured approach to scene recreation. The schema organizes information across three main entities: frames 278, which contain fundamental temporal and environmental data; objects 280, which store detailed object characteristics including location and movement scores, and relationships 284, which capture the spatial and contextual connections between objects. FIG. 2E shows the relationships between frames 278, which contains objects 280, which has relationships 284. Based on the video frames 278, scenes can be constructed 282. The video frames 278 can include frame identifier, time, environment, and/or metadata. The objects 280 can include object identifier, frame identifier, class, location, movement score, category, and/or metadata. The relationship 284 can include relationship identifier, object identifiers, type, and/or distance.

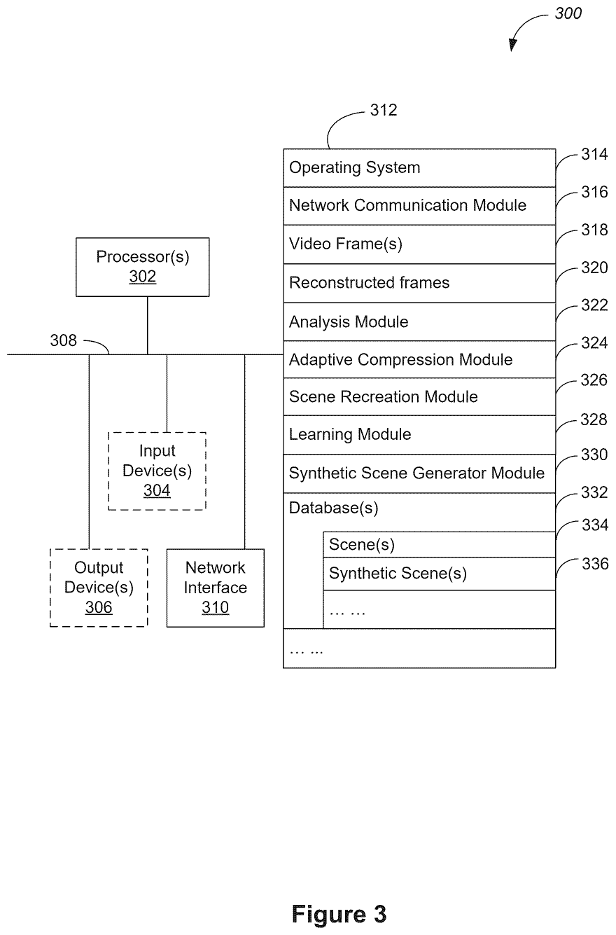

FIG. 3 shows a block diagram of an example computing device 300 for video data management and processing, according to some embodiments. The computing device 200 includes one or more processors 302 for executing instructions and processing data. These may include CPUs, GPUs, and/or specialized processors for tasks like image processing. The computing device 300 also includes a memory 312, a storage for data and instructions, which may include high-speed random access memory and non-volatile storage like flash memory or solid-state drives. The computing device 300 also includes a communication bus 308, which may include one or more interconnects connecting the various hardware components, allowing data transfer between them. The computing device 200 may also include communication interface(s) 310, which enable network connectivity, potentially including Wi-Fi, Bluetooth, or wired connections for data transfer and API communications. The computing device 300 may also include input devices 304 shown as an optional component (dashed lines), which may include controllers, hand-tracking sensors, and/or other mechanisms for user interaction. The computing device 300 may also include one or more output devices 306 (e.g., a display). The computing device 300 may also include power supply, for providing power to the system, which may be a battery for portable use or a connection to a main power.

In some embodiments, the memory 312 includes high-speed random access memory, such as DRAM, SRAM, DDR RAM, and/or other random access solid state memory devices. In some embodiments, the memory 312 includes non-volatile memory, such as one or more magnetic disk storage devices, optical disk storage devices, flash memory devices, or other non-volatile solid state storage devices. In some embodiments, the memory 312 includes one or more storage devices remotely located from the processor(s) 302. The memory 312, or alternatively the non-volatile memory device(s) within the memory 312, comprises a computer readable storage medium. Memory for headsets include, for example, Random Access Memory (RAM), such as Low Power Double Data Rate RAM (LPDDR), used for running the operating system, applications, and/or handling real-time data processing. Memory 312 may also include storage memory, such as flash memory, similar to smartphones (e.g., eMMC or UFS), for storing the operating system, applications, and/or user data. Video memory, often integrated with the GPU in mobile chipsets, can be used to handle graphics processing tasks. Cache memory, such as Static RAM (SRAM), can be used for high-speed memory used by the processors 312 for data access.

In some implementations, the memory 312 stores one or more programs (e.g., sets of instructions), and/or data structures, collectively referred to as “modules” herein. In some implementations, the memory 312, or the non-transitory computer readable storage medium of the memory 312, stores the following programs, modules, and data structures, or a subset or superset thereof:
on operating system 314, which manages system resources and/or processes, and/or provide a platform for other software components;
a network communications module 316, which handles network communications, may be using protocols suitable for real-time data exchange;
video frame(s) 318 (e.g., the video frames 102);
reconstructed frame(s) 320 (e.g., the reconstructed frames 104);
an analysis module 314 (e.g., the analysis module 106);
an adaptive compression module 316 (e.g., the adaptive compression module 108);
a scene recreation module 326 (e.g., the scene recreation module 110);
a learning module 328 (e.g., the learning module 112);
a synthetic scene generator 330 (e.g., the synthetic scene generator 114); and/or
databases 332, which includes scenes 334 (e.g., the scene database 116) and/or synthetic scenes 336 (e.g., the synthetic scene database 118).

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise rearranged in various implementations. In some embodiments, the memory 312 stores a subset of the modules and data structures identified above. Furthermore, in some embodiments, the memory 312 stores additional modules or data structures not described above. Example details and/or operations of the modules, data structures, applications and/or procedures, are further described below, according to some embodiments. Although FIG. 3 shows a computing device, FIG. 3 is intended more as a functional description of the various features that may be present rather than as a structural schematic of the implementations described herein. In practice, and as recognized by those of ordinary skill in the art, items shown separately could be combined and some items could be separated.

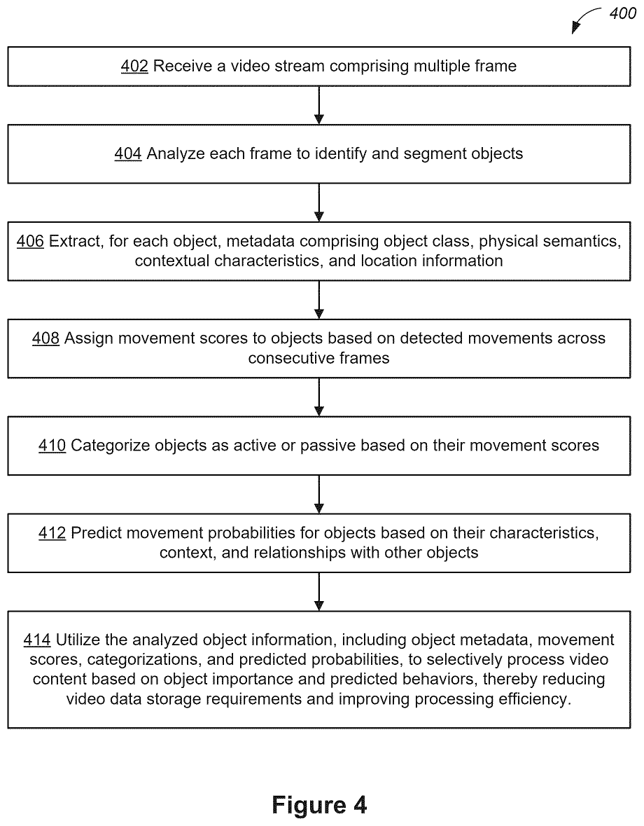

FIG. 4 is a flowchart of an example method 400 for video data management, according to some embodiments. The method 400 can be performed by the computing system 300. The computing device 300, through its processor(s) 302 and memory 312, executes a method that reduces video data storage and improves processing efficiency.

The analysis module 324 receives (402) video frames 318 and performs frame-by-frame analysis to identify and segment (404) objects. For each object, the analysis module 324 extracts (406) metadata comprising object class, physical semantics, contextual characteristics, and location information, as described above in reference to FIG. 2A (the object analysis pipeline 200). In some embodiments, the analysis module 324 processes contextual characteristics including spatial relationships, functional roles within the scene, and potential interactions with other objects, as demonstrated in the example scenario with a person sitting on a chair. In some embodiments, the module captures metadata of light sources in the frame, including location and intensity, to account for their impact on visual perception. For example, the system captures and stores metadata about light sources in the scene, including their locations and intensities, as these factors can impact visual perception and object detection accuracy throughout different times of day. For example, the system tracks how natural light from windows during daytime transitions to artificial LED lighting at night, enabling more accurate object analysis by accounting for changing illumination conditions. This light source tracking can be implemented using computer vision techniques that can detect and characterize both natural and artificial light sources. In some embodiments, the databases 332, including the scene database 334, store object details comprising frame ID, absolute location, relative location to other objects, movement score, metadata, movement probability, and contextual relationships.

The analysis module 324 assigns (408) movement scores to objects based on detected movements across consecutive frames and categorizes (410) them as active or passive. In some embodiments, the analysis module 324 detects object movements between consecutive frames using pixel-level difference calculation or flow-based techniques through the movement scoring component 208. In some embodiments, the analysis module 324 categorizes objects as either active or passive based on their movement scores and predicted movement probabilities. In some embodiments, upon detecting the movements of the objects in consecutive frames, the analysis module 324 assigns the movement scores to various objects. For detecting the movements, any image processing methods, such as pixel level difference calculation or flow-based techniques, can be used. In some embodiments, the resulting movement scores are normalized on a scale (e.g., 0 to 1) to quantify the relative motion intensity of each object, where higher scores indicate more significant movement. These scores can be used for object categorization and help determine appropriate compression strategies for different regions of the frame.

In some embodiments, movement scores are calculated on a normalized scale (e.g., from 0 to 1, where 0 represents complete stasis and 1 represents maximum detected motion relative to frame size). Scores can be computed, for example, using pixel displacement vectors and object boundary changes between consecutive frames. In some embodiments, the analysis module 324 defines regions as interesting when they exhibit one or more of the following quantifiable characteristics: movement scores above a predetermined threshold (e.g., 0.4), interaction proximity (e.g., within 50 pixels) of active objects, or semantic importance scores above a predetermined value (e.g., 0.6) as determined by the attention mechanism. Regions failing to meet these criteria can be classified as uninteresting.

The learning module 328 predicts (412) movement probabilities for objects based on their characteristics, context, and relationships with other objects. In some embodiments, the learning module 328, operating as the prediction system 238, utilizes machine learning or statistical learning algorithms including Bayesian methods, Gaussian mixture models, and transformer-based models. In some embodiments, the learning module 328 considers the object's current position relative to other objects in the scene and updates probabilities based on changes in spatial and/or contextual relationships, as illustrated in the example with books and person proximity. In some embodiments, the learning module 328, through the prediction system 238, predicts future object locations, contexts, and metadata for subsequent frames, and detects unexpected behaviors by comparing predicted and actual object states. This prediction and detection process improves processing efficiency by enabling targeted analysis of relevant frame regions and early detection of anomalies.

In some embodiments, the learning module 328 predicts movement probabilities using conditional probability estimation and machine learning techniques, where the likelihood of an object's movement is calculated based on its relationships with other objects and events in the scene. For example, the system might determine that the probability of a book moving increases significantly when a person is detected nearby, illustrating how the probability of one event (book movement) is dependent on another event (person proximity). This conditional probability approach, combined with statistical learning algorithms and machine learning models, enables the system to make more accurate predictions about object behaviors by considering the interconnected nature of objects and their movements within the scene.

In some embodiments, the learning module 328 determines spatial relationships, functional roles, and/or potential interactions between objects using contextual models and/or convolutional neural networks (CNNs). Spatial relationships can be extracted by analyzing relative positions and orientations between objects in the scene, while functional roles can be identified using state-of-the-art contextual models that understand common object relationships and usage patterns. The system can recognize complex spatial arrangements (e.g., “person standing behind table”) and predict likely interactions by leveraging pre-trained networks that have learned to identify and quantify these relationships from extensive image datasets, without requiring explicit bounding boxes or spatial annotations.

In some embodiments, the prediction engine 248 uses memory-based AI algorithms, including Long Short-Term Memory (LSTM) networks 250, Convolutional LSTM networks, and transformer-based models 254. In some embodiments, the learning module 328 performs comparative analysis between predicted and actual object states using image processing techniques and/or statistical or machine learning-based similarity measures through deviation analysis 260 and anomaly detection 262. For example, the system performs comparative analysis between predicted and actual object states using a variety of established similarity metrics and machine learning techniques. These can include traditional statistical measures, such as cosine similarity, Euclidean distance, and Pearson correlation coefficients, for quantifying differences between predicted and actual object positions, as well as more sophisticated deep learning-based comparison methods that can capture complex differences in object attributes and behaviors. The analysis can be implemented using any combination of these techniques, with the specific choice depending on the application requirements and computational constraints.

In some embodiments, the prediction engine 248 predicts direction, speed of movement, and potential interactions for active objects. In some embodiments, the window manager 244 dynamically adjusts the time interval for prediction based on the rate of change in the scene. For example, the system dynamically adjusts prediction time intervals through learning-based approaches that analyze temporal patterns in scene activity. By recognizing that scenes often exhibit periods of relative stability punctuated by periods of increased activity, such as specific times of day or during particular events, the system can adaptively modify its prediction frequency to optimize computational resources. This adaptive timing can be implemented using AI techniques that learn from historical scene patterns to anticipate when changes are more likely to occur, allowing the system to increase prediction frequency during high-activity periods and decrease it during more static periods.

In some embodiments, the prediction system 238 triggers alerts or actions when detected unexpected behaviors exceed a predefined threshold of deviation from predictions. In some embodiments, the system 300 dynamically adjusts the threshold based on feedback from subject matter experts or automated learning processes. For example, the system dynamically adjusts anomaly detection thresholds through both automated processes and expert feedback mechanisms. The automated adjustments utilize moving averages and seasonality analysis to adapt thresholds based on recent trends and time-based variations in object behaviors, while also incorporating feedback loops where subject matter experts can fine-tune thresholds based on real-time observations and operational requirements. This hybrid approach enables the system to maintain accurate anomaly detection by combining data-driven threshold adaptation with domain expertise, ensuring the system remains sensitive to both gradual behavioral changes and situational context. In some embodiments, the prediction engine 248 utilizes a sliding window approach where data from past n frames predicts details for the next m frames, enabling continuous updating of predictions based on the most recent data.

The computing system 300 also utilizes (414) this object information to selectively process video content, optimizing storage requirements and processing efficiency through smart data management. For example, in some embodiments, the adaptive compression module 326, implementing the framework 212, compresses frame data based on object categorization and movement metrics. The module stores high-resolution images of active objects and low-resolution images of passive ones, applying weighted encoding bitrates that use higher bitrates for interesting regions and lower bitrates for uninteresting regions. In some embodiments, the adaptive compression module 326 determines interesting regions within objects using an attention mechanism from transformer architecture in deep learning. In some embodiments, the adaptive compression module 326 adjusts the frequency of storing high-resolution images for passive objects based on their predicted likelihood of becoming active. For example, the adaptive compression module 326 dynamically adjusts the frequency of high-resolution image storage for passive objects based on conditional probabilities derived from contextual cues, such as increasing the storage frequency for books on a shelf when a person moves closer or exhibits relevant hand gestures that suggest potential interaction. As another example, in some embodiments, the scene recreation module 326 retrieves object details from the scene database 334 for specific frames and recreates scenes based on the object details, using absolute and relative object locations, and adjusting object resolutions based on their stored compression information.

As yet another example of the step 414, in some embodiments, the synthetic scene generator 330, implementing the pipeline 264, generates synthetic scenes representing rare events based on aggregated data from multiple environments. This generation reduces video data storage requirements by eliminating the need to store large volumes of real video data. In some embodiments, the synthetic scene generator 330 aggregates data across multiple environments using clustering, principal component analysis, or deep learning techniques, extracts high-level features of backgrounds and objects, generates diverse backgrounds, and positions synthetic objects using large language or vision models. In some embodiments, the scene validation component 272 validates synthetic scenes using statistical comparison with real data, quality metrics, semantic consistency checks, or human-in-the-loop verification. In some embodiments, the generator 330 maintains environment-specific fidelity based on intended use cases, creates anomalous situations to improve AI model training, extracts and combines objects from different environments to create novel scenarios, and/or generates consecutive frames with motion details to produce synthetic videos for AI model training.

In some embodiments, the system implements adaptive thresholds that are learned based on scene characteristics. Rather than using fixed threshold values, the system employs machine learning regression algorithms to determine appropriate thresholds for each specific scene category. For example, in predominantly static scenes where overall object movement is minimal, the movement probability thresholds are automatically adjusted lower to accurately classify relative object activity within that context. This dynamic threshold adaptation ensures that object activity classifications remain meaningful and contextually appropriate across varying scene types and movement patterns. In some embodiments, the system implements specific thresholds and parameters for optimal performance. For example, objects with movement scores above 0.7 on a normalized scale are categorized as active, while those below 0.3 are categorized as passive. Objects with scores between 0.3 and 0.7 may be categorized based on additional factors, such as their predicted movement probabilities and contextual relationships.

In some embodiments, the sliding window prediction uses a predetermined number of frames (e.g., 30 previous frames) to predict a next predetermined number of frames (e.g., the next 10 frames), though these values may be dynamically adjusted based on scene complexity and processing resources. In high-activity scenes, the prediction window may be reduced (e.g., reduced to 5 frames) to maintain accuracy.

In some embodiments, for adaptive compression, objects are stored at varying resolutions and bit-rates based on their classification. Active objects are stored at higher resolutions and bit-rates to maintain visual quality and detail, while passive objects are stored at lower resolutions and bit-rates to optimize storage efficiency. The compression ratios and resolution selections can be dynamically adjusted based on the object's importance score and predicted activity likelihood, adapting to available storage resources and quality requirements.

In some embodiments, the system implements robust error handling for various edge cases. For example, when object segmentation fails due to poor lighting conditions or occlusion, the system can temporarily maintain the last known object state while increasing the sampling frequency to recapture the object. If an object's movement score cannot be reliably calculated due to rapid scene changes, the system can default to treating the object as active until stable tracking can be reestablished.

In some embodiments, in cases where prediction accuracy falls below a predetermined threshold (e.g., below 85%) for a predetermined number of windows (e.g., three consecutive prediction windows), the system can automatically adjust its prediction parameters and may trigger a recalibration of the movement probability models. The system can also maintain a confidence score for each prediction, allowing downstream processes to adjust their behavior based on prediction reliability.

The system can operate effectively on computing devices with minimum specifications of, for example, quad-core processor at 2.5 GHz, 16 GB RAM, and dedicated GPU with 6 GB VRAM. These specifications can enable processing of 1080p video at 30 fps with average latency under 100 milliseconds for object detection and tracking.

The adaptive compression system can achieve storage reductions (e.g., 60-80%) compared to standard compression while maintaining visual quality (e.g., above 0.85 on the structural similarity index) for active objects, for example. Processing overhead for prediction and analysis can consume minimal (e.g., less than 15% additional) CPU resources compared to traditional compression methods.

In some embodiments, the transformer-based object detection model uses a multi-layer architecture with multiple attention heads per layer, trained on a diverse dataset of annotated video frames. The movement prediction network can include, for example, stacked LSTM layers with configurable hidden units, followed by fully connected layers for probability output. The network architecture and hyperparameters are adaptively determined based on the specific requirements of the deployment scenario and available computational resources.

In some embodiments, the synthetic scene generator uses generative techniques, such as auto-encoders, generative adversarial networks, transformers, and large models (generative AI).

In some embodiments, the system exposes REST APIs for external integration, supporting both synchronous and asynchronous processing modes. The API endpoints can accept video streams in standard formats (e.g., MP4, H.264) and return processed results in JSON format including object metadata, movement scores, and prediction probabilities. The system can also provide WebSocket interfaces for real-time monitoring and control of processing parameters.

In some embodiments, integration with existing video management systems is facilitated through standard protocols including RTSP for video streaming and MQTT for event notifications. The system can be deployed as containerized microservices, with each major component (object detection, movement analysis, prediction) scalable independently based on processing demands.

In some embodiments, the system implements continuous validation through multiple quality metrics. Object detection accuracy can be validated, for example, using intersection over union (IoU) scores, maintaining a minimum threshold (e.g., 0.85 for active objects). Movement prediction accuracy can be validated using both mean squared error (MSE) for position predictions and F1-scores for activity classification, with automated retraining triggered if accuracy drops below established thresholds.

In some embodiments, the synthetic scene generation undergoes multi-stage validation including statistical comparison with real scenes using various content evaluation metrics, such as Fréchet Inception Distance (FID) scores, Kernel Inception Distance (KID), Learned Perceptual Image Patch Similarity (LPIPS), Spatio-Temporal LPIPS (ST-LPIPS), and other similar metrics. The system is not limited to these metrics and can incorporate new evaluation methods as they emerge. Additionally, the validation process may include periodic human expert review of generated sequences to ensure quality standards are maintained.

In this way, the method 400 significantly improves processing efficiency and reduces storage requirements through intelligent object analysis and adaptive compression. By dynamically categorizing objects, predicting their behaviors, and selectively applying compression based on object importance, the system minimizes storage overhead while maintaining high quality representation of critical scene elements. The continuous analysis, prediction, and compression optimization steps are performed as the video stream is received, enabling real time adaptation to changing scene dynamics and ensuring efficient resource utilization across diverse video processing applications.

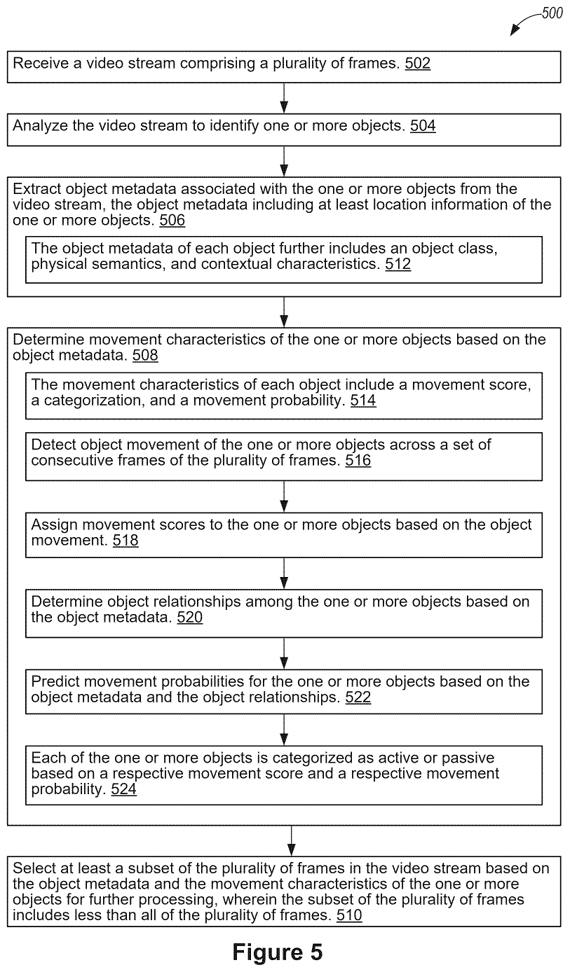

FIG. 5 is a flowchart of another example method 500 for video data management, according to some embodiments. For convenience, the method 500 is described as being implemented by a computing system 300. The computing device 300, through its processor(s) 302 and memory 312, executes a method that reduces video data storage and improves processing efficiency. Method 500 is, optionally, governed by instructions that are stored in a non-transitory computer readable storage medium and that are executed by one or more processors of the computing system. Each of the operations shown in FIG. 5 may correspond to instructions stored in a computer memory or non-transitory computer readable storage medium (e.g., memory 312 in FIG. 3). The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in method 500 may be combined and/or the order of some operations may be changed.

In some embodiments, the computing system 300 receives (operation 502) a video stream including a plurality of frames 102, analyzes (operation 504) the video stream to identify one or more objects, and extracts (operation 506) object metadata 206 associated with the one or more objects from the video stream. The object metadata 206 includes at least location information of the one or more objects. The computing system 300 determines (operation 508) movement characteristics of the one or more objects based on the object metadata 206, and selects (operation 510) at least a subset of the plurality of frames 102 in the video stream based on the object metadata 206 and the movement characteristics of the one or more objects for further processing. The subset of the plurality of frames 102 includes less than all of the plurality of frames 102.

In some embodiments, the computing system 300 analyzes the video stream by segmenting the one or more objects of interest using an image segmentation model. The image segmentation model includes a transformer or a convolutional neural network.

In some embodiments, when the computing system 300 determines movement characteristics of the one or more objects, the computing system 300 detects object movement of the one or more objects across a set of consecutive frames 102 of the plurality of frames 102 based on a pixel-level difference among the set of consecutive frames 102 and assigns movement scores 208 to the one or more objects based on the object movement.

In some embodiments, the computing system 300 creates a movement prediction model based on one or more of: a Bayesian model, a Gaussian mixture model, and a transformer-based model, and applies the movement prediction model to predict movement probabilities for the one or more objects.

In some embodiments, the object metadata 206 of the one or more objects further includes object classes, physical semantics, and contextual characteristics of the one or more objects. The contextual characteristics of the one or more objects further includes a spatial relationship among the one or more objects, functional roles of the one or more objects in a corresponding scene 334, and a potential interaction among the one or more objects.

In some embodiments, the video stream corresponds to a light source. The computing system 300 captures first metadata of the light source in the plurality of frames 102, and the first metadata further includes a location and an intensity level of the light source, thereby accounting for an impact of the light source on visual perception.

In some embodiments, the computing system 300 stores a frame ID, an absolute location, a relative location to a distinct object, a movement score 208, movement probability, and contextual relationships 284 (FIG. 5) with other objects in a database for a first object.

In some embodiments, the computing system 300 predicts movement probabilities for the one or more objects, determines a current position of a first object relative to a set of second objects in a corresponding scene 334, tracks an object relationship 284 among the first object and the set of second objects based on the current position, the object relationship 284 includes spatial and contextual relationships, and updates the movement probabilities based on a change in the spatial and contextual relationships.

In some embodiments, the movement characteristics of each object include a movement score 208, a categorization 210, and a movement probability. When the computing system 300 selects the subset of the plurality of frames 102, the computing system 300 adaptively compresses associated frame data based on the movement characteristics of the one or more objects, wherein the associated frame data include a first element and a second element, and the second element has a priority level or a motion level lower than the first element, and resources allocated to the second element are less than those allocated to the first element.

Further, in some embodiments, the plurality of frames 102 include a first region of interest (ROI), a second ROI having a higher interest level than the first ROI, an active object having a movement score 208 higher than a movement threshold, and a passive object having a movement score 208 lower than the movement threshold. The computing system 300 adaptively compresses frame data by storing image data of the active object with a first resolution and image data of the passive object with a second resolution lower than the active object and applying a weighted encoding bitrate scheme including a first bitrate for the first ROI and a second bitrate for the second ROI. The first bitrate is higher than the second bitrate. Additionally, in some embodiments, the computing system 300 applies an attention mechanism to detect the first ROI and the second ROI. The attention mechanism may be borrowed from a transformer architecture used in deep learning.

In some embodiments, the computing system 300 identifies the passive object in the one or more objects, determines a likelihood of becoming active for the passive object, and adjusting a frequency of storing the image data of the passive object with the first resolution based on the likelihood of becoming active.

In some embodiments, the computing system 300 retrieves the object metadata 206 of the one or more objects from a database for a first image frame, recreates a scene 334 based on the object metadata 206 of the one or more objects, and adjusts an object resolution of at least one object based on associated compression information. Absolute and relative object locations may be applied to recreate the scene 334.

In some embodiments, the object metadata 206 of each object further includes (operation 512) an object class, physical semantics, and contextual characteristics, and the movement characteristics of each object include (operation 514) a movement score 208, a categorization 210, and a movement probability. When the computing system 300 selects the subset of the plurality of frames 102 further processing, the computing system 300 predicts an object state of the one or more objects for one or more subsequent frames 102 that follow a subset of frames 102 based on the object metadata 206 and the movement characteristics associated with the subset of frames 102, determines the object state of the one or more objects based on the object metadata 206 and the movement characteristics associated with the one or more subsequent frames 102, and compares the predicted object state and the determined object state of the one or more objects to detect an unexpected object event. In some situations, the computing system 300 predicts future object states and detects unexpected behaviors, thereby improving processing efficiency by enabling targeted analysis of relevant frame regions and early detection of anomalies.

Further, in some embodiments, the computing system 300 builds a memory-based data processing model including one or more of: a long short-term memory (LSTM) network 250, a convolutional LSTM network, and transformer-based model. The memory-based data processing model is applied to predict the object state of the one or more objects.

In some embodiments, a statistical or machine learns similarity model is applied to compare the predicted object state and the determined object state of the one or more objects and detect the unexpected object event.

In some embodiments, the object state of the one or more objects includes a potential interaction with another object, a movement direction, and a movement speed of an active object.

In some embodiments, the computing system 300 determines a scene 334 change rate in the plurality of frames 102, and dynamically adjusts a time interval for predicts the object state of the one or more objects based on the scene 334 change rate.

In some embodiments, in accordance with a determination that a difference of the predicted object state and the determined object state of the one or more objects exceeds a deviation threshold, the computing system 300 generates an alert message or implements an active action in response to the unexpected object event. Further, in some embodiments, the computing system 300 dynamically adjusts the deviation threshold based on a feedback received from a subject matter expert or an automated learns process.

In some embodiments, when the computing system 300 predicts the object state of the one or more objects, based on a sliding window, at a given time, the computing system 300 applies the object metadata 206 and the movement characteristics of a set of past n frames 102 to predict the object state of the one or more objects for next m frames 102. The sliding window includes a total of m+n frames 102, and is applied to continuously update prediction of the object state. The object state is thereby updated based on the most recent data, improving an accuracy level of future state predictions and enhancing processing efficiency.

In some embodiments, the movement characteristics of each of the one or more objects include a movement score 208, a categorization 210, and a movement probability. The computing system 300 aggregates the object metadata 206 and the movement characteristics of the one or more objects in the plurality of frames 102 to generate image data of a synthetic scene 336 represents a rare event, wherein no real video data is captured during the rare event and stored for the rare event. Further, in some embodiments, when the computing system 300 generates the image data for the synthetic scene 336, the computing system 300 aggregates data across a plurality of environments using clustering, principal component analysis, or deep learns techniques. The data include the object metadata 206 and the movement characteristics of the one or more objects. The computing system 300 extracts high-level features of backgrounds and objects, generates a plurality of backgrounds and a plurality of synthetic objects based on the high-level features of backgrounds and objects, and positions the plurality of synthetic objects in the synthetic scene 336 using a large language model or a large vision model.

In some embodiments, the computing system 300 validates the synthetic scene 336 based on one or more of: statistical comparison with real scene 334 data, quality metrics, semantic consistency check, or human-in-the-loop verification.

In some embodiments, the computing system 300 generates the image data of the synthetic scene 336 by maintaining an environment-specific fidelity level based on an intended use case of the image data of the synthetic scene 336.

In some embodiments, when the computing system 300 generates the image data of the synthetic scene 336, the computing system 300 adds one or more anomalous situations to the synthetic scene 336 by applying the image data of the synthetic scene 336 including the one or more anomalous situations to train a rare event detection model.

In some embodiments, the plurality of frames 102 correspond to a plurality of environments. When the computing system 300 generates the image data of the synthetic scene 336, in some embodiments, the computing system 300 extracts target objects and features corresponding to the plurality of environments from the plurality of frames 102, combines the target objects and features to create one or more visual elements corresponding to a rare event, and adds the one or more visual elements to the synthetic scene 336.

In some embodiments, the computing system 300 generates the image data of the synthetic scene 336 by generating a set of consecutive frames 102 of the synthetic scene 336 based on a speed and a direction of a first object, storing the set of consecutive frames 102 in a database or file storage, combining the set of consecutive frames 102 to generate a synthetic video based on the speed and the direction of the first object, and applying the synthetic video to train a video processing model.

In some embodiments, the object metadata 206 of each object further includes an object class, physical semantics, and contextual characteristics. The computing system 300 determines movement characteristics of the one or more objects by detecting (operation 516) object movement of the one or more objects across a set of consecutive frames 102 of the plurality of frames 102, assigning (operation 518) movement scores 208 to the one or more objects based on the object movement, determining (operation 520) object relationships 284 (FIG. 2E) among the one or more objects based on the object metadata 206, and predicting (operation 522) movement probabilities for the one or more objects based on the object metadata 206 and the object relationships 284. Each of the one or more objects is categorized (operation 524) as active or passive based on a respective movement score 208 and a respective movement probability.

It should be understood that the particular order in which the operations in FIG. 5 have been described are merely exemplary and are not intended to indicate that the described order is the only order in which the operations could be performed. One of ordinary skill in the art would recognize various ways to manage video data. Additionally, it should be noted that details of other processes described above with respect to FIGS. 1-4 are also applicable in an analogous manner to method 500 described above with respect to FIG. 5. For brevity, these details are not repeated here.

The systems and methods described above provide a comprehensive approach to video data management through applications of the object analysis process. The analyzed object information enables adaptive compression that intelligently preserves detail where it matters most, future state prediction that enables early detection of anomalies, and synthetic scene generation that reduces the need for storing extensive real-world data. These applications can work together synergistically. For example, the adaptive compression uses predictions to optimize storage decisions, the anomaly detection benefits from both the detailed object analysis and synthetic training data, and the synthetic scene generation leverages the accumulated object behavior patterns to create realistic scenarios. Together, these capabilities provide a robust solution for efficient video data management that can adapt to diverse use cases while maintaining high performance and resource efficiency.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

The foregoing description, for purpose of explanation, has been described with reference to specific implementations. However, the illustrative discussions above are not intended to be exhaustive or to limit the scope of the claims to the precise forms disclosed. Additionally, the foregoing description, for purpose of explanation, has been described with reference to specific numerical examples (e.g., associated with performance metrics, resource utilization efficiency, and/or task-specific requirements). However, the illustrative discussions above are not intended to be exhaustive or to limit the scope of the claims to the precise numerical examples disclosed. Many modifications and variations are possible in view of the above teachings. The implementations were chosen in order to best explain the principles underlying the claims and their practical applications, to thereby enable others skilled in the art to best use the implementations with various modifications as are suited to the particular uses contemplated.

What is claimed is:

1. A method for reducing video data storage and improving processing efficiency, comprising:
receiving a video stream comprising a plurality of frames;
analyzing the video stream to identify one or more objects;
extracting object metadata associated with the one or more objects from the video stream, the object metadata including at least location information of the one or more objects;
determining movement characteristics of the one or more objects based on the object metadata; and
selecting at least a subset of the plurality of frames in the video stream based on the object metadata and the movement characteristics of the one or more objects for further processing, wherein the subset of the plurality of frames includes less than all of the plurality of frames.

2. The method of claim 1, analyzing the video stream further comprising:
segmenting the one or more objects of interest using an image segmentation model, the image segmentation model including a transformer or a convolutional neural network.

3. The method of claim 1, wherein determining movement characteristics of the one or more objects further comprises:
detecting object movement of the one or more objects across a set of consecutive frames of the plurality of frames, including determining a pixel-level difference among the set of consecutive frames; and
assigning movement scores to the one or more objects based on the object movement.

4. The method of claim 1, further comprising:
creating a movement prediction model based on one or more of: a Bayesian model, a Gaussian mixture model, and a transformer-based model; and
applying the movement prediction model to predict movement probabilities for the one or more objects.

5. The method of claim 1, wherein:
the object metadata of the one or more objects further includes object classes, physical semantics, and contextual characteristics of the one or more objects; and
the contextual characteristics of the one or more objects further includes a spatial relationship among the one or more objects, functional roles of the one or more objects in a corresponding scene, and a potential interaction among the one or more objects.

6. The method of claim 1, wherein the video stream corresponds to a light source, the method further comprising:
capturing first metadata of the light source in the plurality of frames, wherein the first metadata further includes a location and an intensity level of the light source.

7. The method of claim 1, further comprising:
for a first object, storing a frame ID, an absolute location, a relative location to a distinct object, a movement score, movement probability, and contextual relationships with other objects in a database.

8. The method of claim 1, further comprising:
predicting movement probabilities for the one or more objects;
determining a current position of a first object relative to a set of second objects in a corresponding scene;
tracking an object relationship among the first object and the set of second objects based on the current position, the object relationship including spatial and contextual relationships; and
updating the movement probabilities based on a change in the spatial and contextual relationships.

9. A computing system for reducing video data storage and improving processing efficiency, the computing system comprising:
one or more processors; and
memory storing one or more programs configured for execution by the one or more processors, the one or more programs comprising instructions for:
receiving a video stream comprising a plurality of frames;
analyzing the video stream to identify one or more objects;
extracting object metadata associated with the one or more objects from the video stream, the object metadata including at least location information of the one or more objects;
determining movement characteristics of the one or more objects based on the object metadata; and
selecting at least a subset of the plurality of frames in the video stream based on the object metadata and the movement characteristics of the one or more objects for further processing, wherein the subset of the plurality of frames includes less than all of the plurality of frames.

10. The computing system of claim 9, wherein the movement characteristics of each object include a movement score, a categorization, and a movement probability, and selecting the subset of the plurality of frames further comprises:
adaptively compressing associated frame data based on the movement characteristics of the one or more objects, wherein the associated frame data include a first element and a second element, and the second element having a priority level or a motion level lower than the first element, and resources allocated to the second element are less than those allocated to the first element.

11. The computing system of claim 10, wherein:
the plurality of frames include a first region of interest (ROI), a second ROI having a higher interest level than the first ROI, an active object having a movement score higher than a movement threshold, and a passive object having a movement score lower than the movement threshold; and
adaptively compressing frame data further comprises:
storing image data of the active object with a first resolution and image data of the passive object with a second resolution lower than the active object; and
applying a weighted encoding bitrate scheme including a first bitrate for the first ROI and a second bitrate for the second ROI, the first bitrate higher than the second bitrate.

12. The computing system of claim 11, further comprising applying an attention mechanism to detect the first ROI and the second ROI.

13. The computing system of claim 11, the one or more programs further comprising instructions for:
identifying the passive object in the one or more objects;
determining a likelihood of becoming active for the passive object; and
adjusting a frequency of storing the image data of the passive object with the first resolution based on the likelihood of becoming active.

14. The computing system of claim 10, the one or more programs further comprising instructions for:
retrieving the object metadata of the one or more objects from a database for a first image frame; and
recreating a scene based on the object metadata of the one or more objects; and
adjusting an object resolution of at least one object based on associated compression information.

15. A non-transitory computer-readable storage medium storing one or more programs configured for execution by one or more processors of a computing system, wherein the computing system includes a memory hierarchy, and the one or more programs comprise instructions for:
receiving a video stream comprising a plurality of frames;
analyzing the video stream to identify one or more objects;
extracting object metadata associated with the one or more objects from the video stream, the object metadata including at least location information of the one or more objects;
determining movement characteristics of the one or more objects based on the object metadata; and
selecting at least a subset of the plurality of frames in the video stream based on the object metadata and the movement characteristics of the one or more objects for further processing, wherein the subset of the plurality of frames includes less than all of the plurality of frames.

16. The non-transitory computer-readable storage medium of claim 15, wherein the object metadata of each object further includes an object class, physical semantics, and contextual characteristics, and the movement characteristics of each object include a movement score, a categorization, and a movement probability, selecting the subset of the plurality of frames further comprising:
predicting an object state of the one or more objects for one or more subsequent frames that follow a subset of frames based on the object metadata and the movement characteristics associated with the subset of frames;
determining the object state of the one or more objects based on the object metadata and the movement characteristics associated with the one or more subsequent frames; and
comparing the predicted object state and the determined object state of the one or more objects to detect an unexpected object event.

17. The non-transitory computer-readable storage medium of claim 16, the one or more programs further comprising instructions for:
building a memory-based data processing model including one or more of: a long short-term memory (LSTM) network, a convolutional LSTM network, and transformer-based model, wherein the memory-based data processing model is applied to predict the object state of the one or more objects.

18. The non-transitory computer-readable storage medium of claim 16, wherein a statistical or machine learning similarity model is applied to compare the predicted object state and the determined object state of the one or more objects and detect the unexpected object event.

19. The non-transitory computer-readable storage medium of claim 16, wherein the object state of the one or more objects includes a potential interaction with another object, a movement direction, and a movement speed of an active object.

20. The non-transitory computer-readable storage medium of claim 16, the one or more programs further comprising instructions for:
determining a scene change rate in the plurality of frames; and
dynamically adjusting a time interval for predicting the object state of the one or more objects based on the scene change rate.
